(19) United States
(12) Patent Application Publication
(10) Pub. No.: US 2007/0153629 A1
(43) Pub. Date: Jul. 5, 2007

(54) Acoustic isolator

(76) Inventors: Douglas S. Drumheller, Cedar Crest, NM (US); Paul L. Camwell, Calgary (CA); Anthony R. Dopf, Calgary (CA)

Correspondence Address: GOWLING LAFLEUR HENDERSON LLP, SUITE 1400, 700 2ND ST. SW, CALGARY, AB, T2P 4V5, CA

(21) Appl. No.: 11/606,818

(22) Filed: Dec. 1, 2006

Related U.S. Application Data
(60) Provisional application No. 60/741,907, filed on Dec. 5, 2005.

(51) Int. Cl. G01V 1/00

(52) U.S. Cl. 367/162; 367/76

(57) ABSTRACT

An acoustic isolator for use with tubular assemblies such as drillpipe or production tubing comprising an acoustic wave transmitter, the acoustic isolator comprising, in series, an odd integer λ/4 multiple tuning bar of first acoustic impedance adjacent the acoustic wave transmitter, an odd integer λ/4 multiple reflector tube of second acoustic impedance, and a snubber of third acoustic impedance, wherein there is an acoustic impedance mismatch between the odd integer λ/4 multiple tuning bar and the odd integer λ/4 multiple reflector tube and an acoustic impedance mismatch between the odd integer λ/4 multiple reflector tube and snubber, such that a “down” wave propagated toward the isolator is reflected back substantially in phase with an “up” wave propagated from the acoustic wave source away from the isolator. Furthermore, the acoustic isolator is similarly effective in reflecting “up” propagating waves originating from below the isolator, hence further protecting the acoustic wave source from possible deleterious interference.

### FIELD OF THE INVENTION

The present invention relates to telemetry apparatus and methods, and more particularly to acoustic telemetry apparatus and methods used in the oil and gas industry.

### BACKGROUND OF THE INVENTION

Acoustic telemetry is a method of communication in the well drilling and production industry. In a typical drilling environment, acoustic carrier waves from an acoustic telemetry device are modulated in order to carry information via the drillpipe to the surface. Upon arrival at the surface, the waves are detected, decoded and displayed in order that drillers, geologists and others helping steer or control the well are provided with drilling and formation data.

The theory of acoustic telemetry as applied to communication along drillstrings has a long history, and a comprehensive theoretical understanding was eventually achieved and backed up by accurate measurements. It is now generally recognized that the nearly regular periodic structure of drillpipe imposes a passband/stopband structure on the frequency response, similar to that of a comb filter. Dispersion, phase non-linearity and frequency-dependent attenuation make drillpipe a challenging medium for telemetry, which situation is made even more challenging by the significant surface and downhole noise generally experienced.

The design of acoustic systems for static production wells has been reasonably successful, as each system can be modified within economic constraints to suit these relatively long-lived applications. The application of acoustic telemetry in the plethora of individually differing real-time drilling situations, however, is much less successful. This is primarily due to the increased noise due to drilling, and the problem of unwanted acoustic wave reflections associated with downhole components, such as the bottom-hole assembly (or “BHA”), typically attached to the end of the drillstring, which reflections can interfere with the desired acoustic telemetry signal. The problem of communication through drillpipe is further complicated by the fact that drillpipe has heavier tool joints than production tubing, resulting in broader stopbands; this entails relatively less available acoustic passband spectrum, making the problems of noise and signal distortion more severe.

To make the situation even more challenging, BHA components are normally designed without any regard to acoustic telemetry applications, enhancing the risk of unwanted and possibly deleterious reflections caused primarily by the BHA components.

When exploring for oil or gas, or in coal mine drilling applications, an acoustic transmitter is preferentially placed near the BHA, typically near the drill bit where the transmitter can gather certain drilling and formation data, process this data, and then convert the data into a signal to be broadcast to an appropriate receiving and decoding station. In some systems, the transmitter is designed to produce elastic extensional stress waves that propagate through the drillstring to the surface, where the waves are detected by sensors, such as accelerometers, attached to the drill string or associated drilling rig equipment. These waves carry information of value to the drillers and others who are responsible for steering the well.

Exploration drilling in particular has become a highly evolved art, wherein the specification and placement of the BHA components is almost entirely dictated by the driller's need to drill as quickly and accurately as possible while gathering information local to the drill bit. A large variety of specialized BHA modules or tools are available to suit local conditions, and their inclusion in a BHA usually takes priority over the requirements of telemetry methods, acoustic or otherwise.

The diversity of these BHA tools and the decision regarding whether or not to even include them in a drillstring, pose major issues for consideration; these issues have a significant impact when dealing with acoustic energy questions. Cyclic acoustic waves suffer multiple reflections and amplitude changes even in a very simple BHA, and the net effect of these changes may destructively interfere with the required acoustic telemetry broadcast signal. The reflections are caused by impedance mismatches, which are the result of mechanical discontinuities present in all BHAs presently in use.

An initial response to this problem would be to place the acoustic telemetry device above the BHA and simply direct the acoustic energy up the drillstring, away from the BHA components. Unfortunately, this does not fully address the problem because typical acoustic transmitters emit waves of equal magnitude both up-hole and downhole, and the downward travelling waves in particular may be reflected resulting in destructive interference with the upward travelling waves. In the worst cases, this can cause virtually complete cancellation of the upward travelling communication signal.

It is known in other fields, for example in radio frequency transmitter design and electrical transmission lines, that wave reflections can be controlled by inserting simple specific impedance changes at certain distances from a transmitter, such that the combination of the original wave and the reflected wave combine constructively to produce a single wave travelling in one direction with increased amplitude. The standard approach is to insert a “quarter wave” (λ/4) impedance change (or odd integer multiples thereof, i.e. n_{odd}λ/4) adjacent to the transmitter so that one wave (the “down” wave) is reflected in phase with the intended transmitted wave (the “up” wave) and constructively aids the intended transmitted wave by increasing its amplitude.

Downhole applications typically employ transmitters that emit stress waves of nearly equal, but not necessarily equal, magnitude in both directions. Moreover, each wave has the same sign in stress but opposite sign in material velocity. In such cases, the appropriate reflection device would be a n_{odd}λ/4 tuning bar placed below the transmitter. However, such a simple solution is often impractical because the equipment below the acoustic transmitter is designed to drill and steer the well rather than to aid telemetry. Equipment such as drill collars, crossover pipes, drilling motors and bits can easily nullify the benefit of simply introducing a n_{odd}λ/4 section of pipe below the acoustic transmitter because the equipment will generally be of differing lengths and impedances that can add to the n_{odd}λ/4 section and eliminate the intended benefit. Other styles of transmitters, which emit waves in both directions having different relationships between their stresses and material velocity, would require tuning bars of different lengths, not necessarily n_{odd}λ/4 sections, further complicating the problem.

As mentioned above, downhole noise is also of concern in acoustic telemetry. The problem of downhole noise is addressed to some extent in U.S. Pat. No. 6,535,458 to Meehan, wherein is taught a baffle filter comprising a periodic structure of typically 20 m length interposed above or below the acoustic sub; this is intended to cause stopbands over a certain range of frequencies, the position of the baffle being to protect the acoustic transmitter from the sources of the noise. This teaching, however, does not address or anticipate the more serious problem of energy propagating in a “down” direction being reflected in a relatively unattenuated manner back to the transmitter where it may combine in a destructive manner with the energy propagating in an “up” direction, thereby causing possibly significant destruction of the signal intended to reach the surface.

As can be seen, then, the required upward travelling acoustic telemetry waves are often interfered with by unwanted reflections from impedance mismatches below the transmitter. The known art of inserting a tuning bar of appropriate length is usually ineffective because the local conditions often necessitate the addition of further BHA components that cause further reflections that can often destructively interfere with the upward travelling wave.

### SUMMARY OF THE INVENTION

It is an object of the present invention to control the down wave reflections, in particular, in such a manner as to mitigate the otherwise potentially destructive reflections from interfering with the up wave. Specifically, the present invention comprises an apparatus for placement below the transmitter, and a method for using same, that will beneficially reflect the down waves, such that:
A. the apparatus can be configured to be effective over a certain broadcast bandwidth, such that all the desired frequencies in a modulated telemetry signal are significantly and beneficially reflected at known places; and
B. the apparatus aids the up wave by adding in phase, providing up to a 3 dB gain in the wave amplitude and a 6 dB gain in the wave energy.

An apparatus according to the present invention seeks to effectively isolate essentially all down waves from the subsequent BHA components, thus curtailing the possibility of waves that would have entered the BHA and returned with potentially destructive phases. Positioning an apparatus according to the present invention below the transmitter can, in effect, make the lower BHA components essentially “acoustically invisible” over a bandwidth useful for acoustic telemetry.

The present invention is also intended to be applicable in situations other than real-time drilling with drillpipe or production wells with production tubing. For example, many relatively shallow wells are drilled with coiled tubing. Although coiled tubing does not have the passband/stopband features of drillpipe, it does have BHA components similar to those in jointed pipe applications. Thus, the apparatus and method taught herein are intended to apply equally to the situation of coiled tubing.

It is intended that the present invention be applicable in still further applications. For example, an isolation/reflection means as described herein can also be beneficial in production wells where there may not be a BHA as such, but there may instead be production components such as valves, manifolds, screens, gas lift equipment, etc., below the acoustic source. Thus, the apparatus and method taught herein are intended to apply equally to this situation.

It is not intended that an exhaustive list of all such applications be provided herein for the present invention, as many further applications will be evident to those skilled in the art.

In the following description, reference is made to “up” and “down” waves, but this is merely for convenience and clarity. It is to be understood that the present invention is not to be limited in this manner to conceptually simple applications in acoustic communication from the downhole end of the drillstring to the surface. It will be readily apparent to one skilled in the art that the present invention applies equally, for example, to subsurface stations, such as would be found in telemetry repeaters.

According to a first aspect of the present invention, then, there is provided an acoustic isolator for use with tubular assemblies comprising an acoustic wave transmitter, the acoustic isolator comprising, in series:
a first tubular member of first acoustic impedance adjacent the acoustic wave transmitter;
a second tubular member of a second acoustic impedance, the first acoustic impedance being different than the second acoustic impedance; and
a third tubular member of third acoustic impedance, the third acoustic impedance being different than the second acoustic impedance;
   whereby a first wave propagated toward the first tubular member is reflected back substantially in phase with a second wave propagated away from the first tubular member.

According to a second aspect of the present invention there is provided a method for acoustically isolating a wave reflection source in a tubular assembly, the method comprising:
a. providing the tubular assembly with an acoustic wave transmitter;
b. providing the tubular assembly with, in series, a first tubular member of first acoustic impedance adjacent the acoustic wave transmitter, a second tubular member of a second acoustic impedance, the first acoustic impedance being different than the second acoustic impedance, and a third tubular member of third acoustic impedance, the third acoustic impedance being different than the second acoustic impedance, wherein there is an acoustic impedance mismatch between the first and second tubular members and an acoustic impedance mismatch between the second and third tubular members, the first, second and third tubular members being positioned between the acoustic wave transmitter and the wave reflection source;
c. allowing the acoustic wave transmitter to propagate a first acoustic wave in a first direction along the tubular assembly toward the first tubular member;
d. allowing the acoustic wave transmitter to propagate a second acoustic wave in a second direction along the tubular assembly away from the first tubular member; and
e. allowing the acoustic impedance mismatches to cause reflection of the first wave substantially in phase with the second wave.

In exemplary embodiments of the present invention, the first tubular member is a tuning bar appropriate to the transmitter type, the second tubular member is an odd integer multiple reflector tube, and the third tubular member is a snubber. The acoustic impedances of the first and third tubular members may be generally equal, or the third acoustic impedance may be greater or less than the first acoustic impedance but different than the second acoustic impedance.

Typical acoustic transmitters presently being placed in drillstrings or production tubing generate upward periodic travelling waves and similar downward travelling periodic waves. The teaching herein is limited to the most common situation, in which the stresses of the upward and downward waves are in phase while the material velocities are 180° out of phase, but it is to be recognized that the present invention is easily applied to situations in which these two waves have different phase relationships, and the implementation of the present invention would simply require the application of tuning bar lengths that differ from n_{odd}λ/4.

A detailed description of an exemplary embodiment of the present invention is given in the following. It is to be understood, however, that the invention is not to be construed as limited to this embodiment.

### BRIEF DESCRIPTION OF THE DRAWINGS

In the accompanying drawings, which illustrate the principles of the present invention and an exemplary embodiment thereof:

FIG. 1 is a simplified diagrammatic representation of two bars of differing acoustic impedances joined at a common interface, with an incident up wave, a transmitted up wave, and a reflected down wave travelling through them;

FIG. 2 is a simplified diagrammatic representation of two bars of different impedances, separated by a bar of differing impedance and n_{odd}λ/4 long;

FIG. 3 is a simplified diagrammatic representation of an acoustic isolator according to the present invention comprising: a lead zirconium titanate (PZT) transmitter between two acoustic sub sections, a tuning bar, a reflector tube, a snubber and an extension to the rest of the BHA;

FIG. 4 is a Fourier transform plot of an accelerometer signal detecting a broadcast signal from (1) an acoustic sub attached to approximately 60 lengths of drillpipe, and then (2) with the addition to the sub of a n_{odd}λ/4 tuning bar;

FIG. 5 is a Fourier transform plot of an accelerometer signal detecting a broadcast signal from (1) an acoustic sub alone, and then (2) with the combined addition of a n_{odd}λ/4 tuning bar and a n_{odd}λ/4 reflector tube attached to approximately 60 lengths of drillpipe; and

FIG. 6 is a Fourier transform plot of an accelerometer signal detecting a broadcast signal from (1) an acoustic sub alone, and then (2) with the combined addition of a n_{odd}λ/4 tuning bar, a n_{odd}λ/4 reflector tube and a short length of drill collar (a “snubber”) attached to approximately 60 lengths of drillpipe.

### DETAILED DESCRIPTION OF A PREFERRED EMBODIMENT

The focus of the present invention is to understand and implement designs of tubular members (pipes of various types) such that judicious control of their impedances may result in a useful and necessary apparatus, an acoustic isolator.

As waves travel through pipe they create both tractive forces and motion in the material. The tractive force, or simply traction, is equal to the axial stress times the cross-sectional area. Positive and negative tractions mean that the material is either in tension or compression, respectively. The parameter called the acoustic impedance z is important as it is a proportionality constant that connects the traction to the velocity of the material produced by simple waves propagating up and down the pipe. The acoustic impedance z of a section of pipe is
z=p c A, [1]
where
p=material mass density
c=bar wave velocity
A=wall area of the pipe.

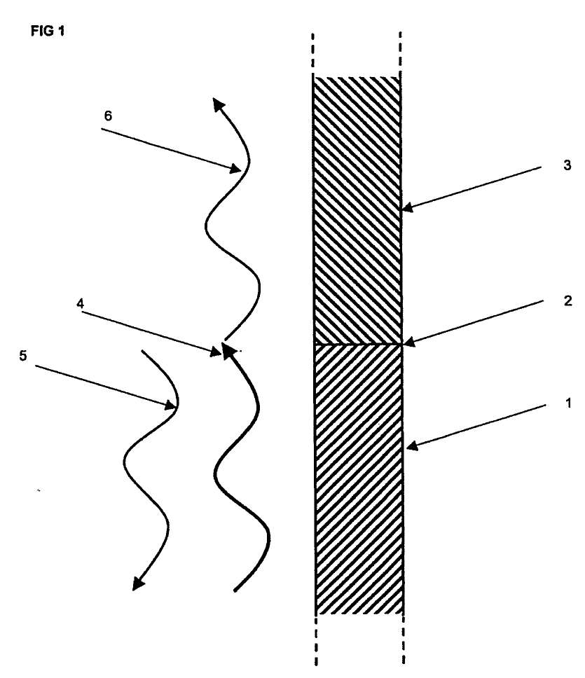

Referring now to FIG. 1, which illustrates a basic principle underlying the present invention, two pipes 1 and 3 are shown joined at a common interface 2. An incident simple wave 4 with traction amplitude I travels upwardly until it encounters the interface 2, resulting in a transmitted wave 6 with traction amplitude T and a reflected wave 5 with traction amplitude R. The acoustic impedance of pipe I is z₁, and the acoustic impedance of pipe 3 is z₂. The ratios connecting the reflected, transmitted, and incident tractions for this example are
R/I=(1−K)/(1+K) [2]
and
T/I=2/(1+K) [3]
where
K=z₁/z₂ [4]

Three special cases can then assist in understanding the implications of this basic principle:
i) K=1 which yields R/I=0 and T/I=1

This implies the two segments have equal impedance: z₁=z₂.
ii) K=∞, thus R/I=−1 and T/I=0 This implies that the interface becomes a traction-free boundary where z₂=∞.
iii) K=0,thus R/I=+1 and T/I=2 This implies that the interface becomes a motionless rigid boundary where z₂=∞.

In case i), the incident wave travels uninterrupted through the interface 2 without reflection. In case ii), the wave is completely reflected with a traction phase change of 180° and consequently the traction is zero at the interface. In case iii), the wave is completely reflected with no traction phase change and consequently the traction doubles at the interface.

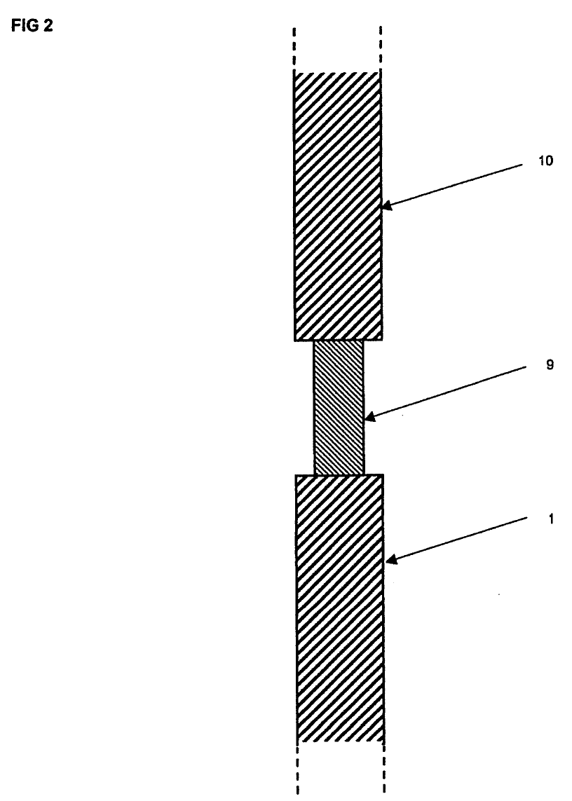

L. M. Brekhovskikh (Waves in Layered Media, 2^{nd} ed., Academic Press, 1980) analyzes waves passing through a more complicated system, such as is illustrated in FIG. 2. The relationships, which are similar to equations [2] and [3] for the ratios of the tractions, are
R/I=(1−K_{q}Kₛ)/(1+K_{q}Kₛ) [5]
and
T/I=2Kₛ/(1+K_{q}Kₛ) [6]
where
K_{q}=z₁/z₂ [7]
Kₛ=z₃/z₂ [8]

Applying equations [5] and [6] in the downhole drilling and production context can enable novel methods of implementing extremely efficient reflecting devices, particularly as a result of the K_{q}Kₛ terms.

### EXAMPLE 1 (K_{q}=Kₛ=K)

Referring now to FIG. 2, three segments are illustrated: (1) segment 1, a pipe with impedance z₁; (2) segment 9, a λ/4 pipe with impedance Z₂; and (3) segment 10, a pipe with the same impedance z₁ as segment 1. In this case we see that equations [5] and [6] become:
R/I=(1−K²)/(1+K²) [9]
and
T/I=2K/(1+K²) [10]
where we now define K to be
Kₛ=K_{q}=(z₁/z₂)≡K [11]

Equations [9] and [10] apply to an incident wave approaching the n_{odd}λ/4 section 9 from either direction. Where segments 1 and 10 are pipes that are standard oilfield alloy steel drill collars it is straightforward to calculate their acoustic impedance. In order to implement a significant impedance mismatch, then, we could, for example, use a thin-walled, small diameter n_{odd}λ/4 titanium pipe for segment 9. An attainable value for K in this circumstance would be 7.8, leading to values for R/I and T/I of −0.968 and 0.252, respectively. Considering special case ii) discussed above, it can be seen that the reflection properties of this example approach that of a traction-free boundary. Indeed the amplitude of the reflection is only slightly less than the ideal value of −1. Moreover, for waves approaching in either direction the titanium section 9 acoustically isolates the drill collars from each other. When segments 1 and 10 have the same impedance this isolation can be calculated as 20 log₁₀(T/I), which in this case yields 12 dB reduction in the transmitted energy. This method may be extended to stack such impedance mismatches if the isolation has to be of an even greater value.

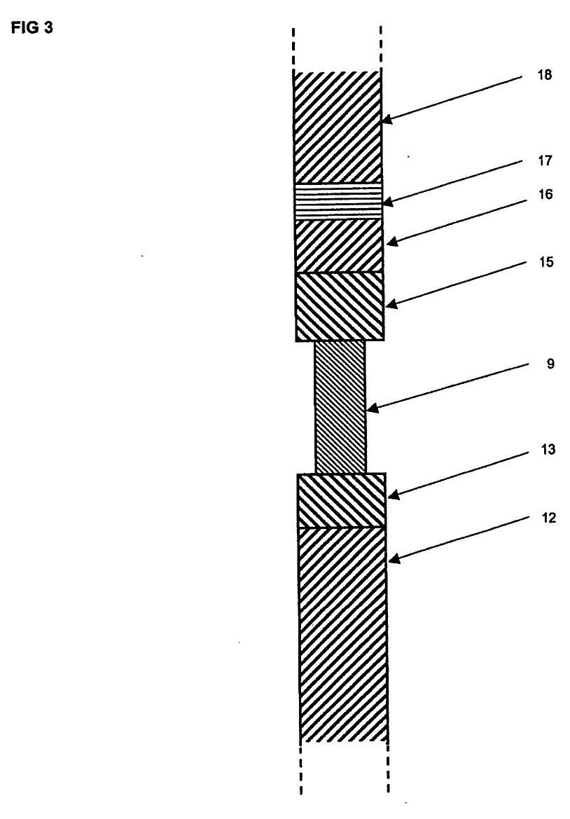

Referring now to FIG. 3, the above can be applied to a more realistic downhole situation. An acoustic transmission device 17, such as PZT built into a drill collar 18, will transmit substantially equally in both upward and downward directions. Ideally, the components below the PZT 17 would comprise an n_{odd}λ/4 extension terminating in a drill bit. In many instances, however, such as when drilling directional wells, this simple situation is not possible, so the exemplary embodiment taught herein is directed to further controlling the effects of the down wave, as follows.

In the down direction, an acoustic wave travels through the lower portion 16 of the collar and on into an extension 15 with the same impedance z₁; this extension combined with the lower portion 16 acoustically comprises an n_{odd}λ/4 tuning bar. The wave then encounters an n_{odd}λ/4 reflector tube 9 of acoustic impedance Z₂. Next is a snubber section 13, again with impedance z₁ but now simply a short section of drill collar. The snubber 13 is attached in this exemplary embodiment to the rest of the BHA 12 whose impedances and subassembly lengths are not controlled.

It will now be clear via the application of equation [5] above that the BHA characteristics below the snubber 13 are essentially irrelevant because the tuning sections characterized by the impedance mismatches substantially and beneficially return essentially all of the down wave energy from the transmitter 17 in proper phase with the original wave. This may be illustrated by considering the following situation, where for simplicity we suppose that the transmitter is short so that the up and down energy appear to come from a single point and we also suppose that the n_{odd}=1 so that the resonant sections are simple quarter-wave lengths. Clearly we can view this system at an instant in time so that the motion, forces, and waves are frozen in place. At this instant the transmitter 17 is radiating equals amount of energy both up and down. We see that the wave traveling down undergoes a 90° phase shift as it passes through the lower section 16 and the tuning bar 15, then because R/I is negative it shifts 180° in phase as it reflects from the interface between the tuning bar 15 and the reflector tube 9, and then it undergoes another 90° phase shift returning along the tuning bar 15 and the lower section 16. Indeed, we see that the energy radiated downward from the transmitter 17 undergoes a 360° phase shift upon its return to the transmitter 17 and therefore combines constructively with the energy that is being radiated directly upward by the transmitter 17. Moreover, as R/I is very close to −1, the amplitude of the upward wave is effectively and beneficially doubled. By this method it is a very straightforward matter to account for the phase shifts and time delays due to segments and interfaces (as appropriate) comprising the transmitter 17, the tuning bar 15, the lower section 16, the reflector tube 9 and the snubber 13 in this essentially one-dimensional structure. We also know that the small amount of energy from the transmitter that does pass through the isolator to the BHA suffers a 12 dB reduction and if it is reflected in an uncontrolled manner from the BHA 12 components below the snubber 13 it will undergo another 12 dB reduction before returning to the transmitter for a total reduction of 24 dB in the uncontrolled transmitter energy. This makes the reflection characteristics of the BHA basically irrelevant to the function of the transmitter. It will now be apparent that, as a collateral benefit, any in-band energy originating below the snubber 13 from other sources is also reflected back down where it can do no harm to the up signal being generated by the transmitter 17.

It is not obvious from the foregoing that the snubber 13 can be substantially shorter than the preceding sections with only negligible effects on the isolation, although this has been established through experimentation and the analysis method of Drumheller (see D. S. Drumheller, Extensional stress waves in one-dimensional elastic waveguides, J. Acoustical Society of America, 92, December 1992). In other experimental embodiments, snubbers as short as λ/24 have worked successfully. Tests have demonstrated the effect of varying the section lengths below the n_{odd}λ/4 reflector tube 9, and have also shown the beneficial reflection properties of the present invention. In these tests, a sweep of frequencies has been generated that is compatible with the desired broadcast band. The centre broadcast frequency of the signal is taken to define the nominal wavelength—this being used as the measure of the various resonant reflecting components. The frequency and amplitude are normalized to this centre frequency in the following.

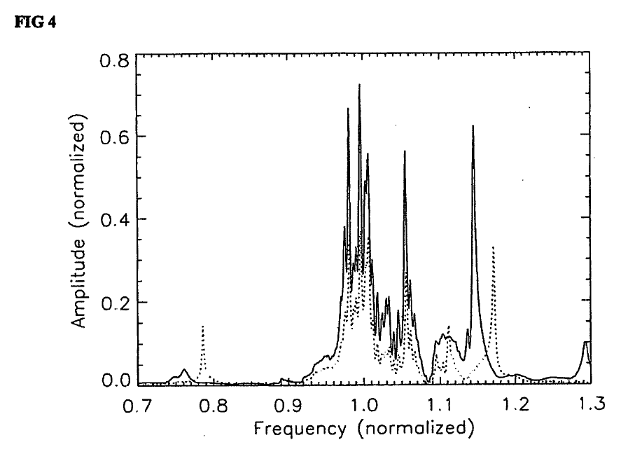

In a first test, all components below the PZT transmitter 17 were removed except for a short portion (λ/12) of the n_{odd}λ/4 tuning bar (which happens to be an integral portion of the transmitter sub and corresponds to the lower section 16 in FIG. 3). Thus prepared, the upper part of the transmitter sub was connected to a drillstring comprising approximately 60 pipe lengths. This drillstring exhibited a well-established passband structure typical of a realistic drilling or production situation. An accelerometer was attached at the middle point of this string. The dashed line in FIG. 4 shows the Fourier transform of the accelerometer signal resulting from a broadcast from the transmitter sub. The solid line shows the effect of adding more pipe such that the optimal n_{odd}λ/4 tuning bar was reassembled on the lower part of the sub. Several features are evident, the most important for present purposes being that the signal amplitude essentially doubled in the presence of the tuning bar. If no part of this bar had been present, the signal would have nearly disappeared.

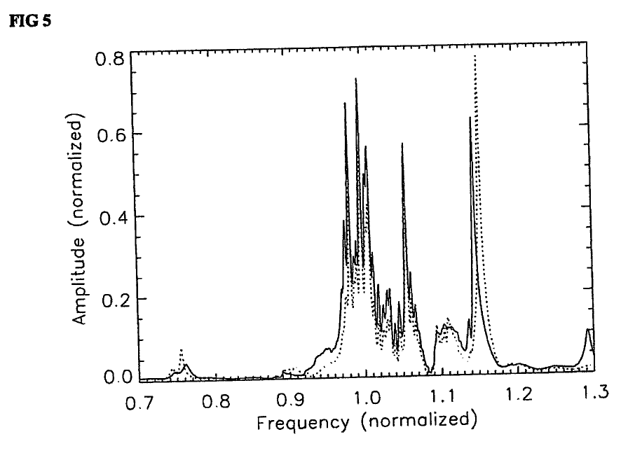

FIG. 5 shows what happened when the n_{odd}λ/4 reflector tube 9 was added to the n_{odd}λ/4 tuning bar. The solid line is from the n_{odd}λ/4 tuning bar alone, and the dashed line is when the n_{odd}λ/4 reflector was added. It is evident that the addition of the reflector slightly damages the signal.

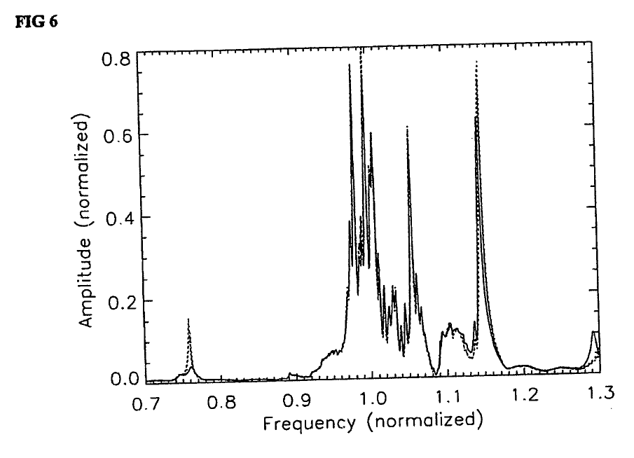

Next, the snubber was added, resulting in the dashed line seen in FIG. 6. There is little difference between this dashed line and the optimal response (solid line) of the n_{odd}λ/4 tuning bar alone. Close inspection of FIG. 6 reveals that there are actually four dashed lines, three of which are due to successively adding λ/12 segments of bar below the snubber. These additional segments each have the same acoustic impedance as the snubber and the transmitter. Significantly, the signal is clearly unaffected by their addition, demonstrating that a broadcast response close to the optimal has been achieved and that additions of components below the snubber have minimal effect on the signal. This has been confirmed by subsequent experiments.

### EXAMPLE 2 (K_{q}≠Kₛ)

In another example, the impedance of the snubber 13 is increased, to maximize the acoustic mismatch between it and the reflector tube 9. Because one may run into practical limitations associated with increasing the wall area (see equation [1]), an alternative is to vary the material mass density ρ. For example, as most components of the drillstring are steel the snubber 13 may be constructed from a hollow steel housing filled with lead. An attainable impedance mismatch between a titanium reflector 9 and a denser snubber 13 is Kₛ=14.3, and as before the impedance mismatch between the λ/4 tuning bar 15 and the λ/4 reflector bar 9 is K_{q}=7.8. Equations [5] and [6] then enable calculation of R/I=−0.982 and T/I=0.254. While these numbers do not immediately indicate a significant improvement in isolation we must also recognize that we have now created another impedance mismatch between the snubber [13] and the drill collar [12] that improves the isolation. This new interface is not incorporated into equations [5] and [6] derived from the Brekovskikh analysis but we can account for it through the methods of Drumheller that show several important effects on the isolation: (1) it increases from 12 to 15.4 dB at the center broadcast frequency; (2) it improves over a broader broadcast band; and (3) it is still symmetric in that isolation of 15.4 dB applies to both upward and downward traveling waves. Consequently, wave energy from the transmitter that does make it into the BHA is now reduced by at least 30.8 dB before returning in an uncontrolled manner to the transmitter.

It is important to recognize that significant isolation can accordingly be achieved without resorting to an expensive titanium reflector, or the use of any other material of lower density than steel (such as aluminum). Attainable impedance coefficients with a steel reflector tube and a steel-lead snubber are K_{q}=4.88 and Kₛ=8.94. This yields a value of −0.955 for R/I and 0.400 for T/I. The Drumheller analysis predicts that the reduction of the uncontrolled transmitter energy is 23 dB when the snubber is λ/8 long and 26.4 dB when the snubber is λ/4 long as compared to 24 dB for the titanium reflector in Example 1. Clearly here the use of steel-lead snubber can replace the need for a titanium reflector. Moreover, the λ/4 snubber also offers a slight improvement in isolation but this must be weighed against the penalty of its increased mass.

As stated above, references to “up” and “down” waves are merely for convenience and clarity, and it is to be understood that the present invention is not limited to conceptually simple applications in acoustic communication from the downhole end of the drillstring to the surface. It will now be clear to one skilled in the art that the present invention applies equally, for example, to subsurface stations, such as would be found in telemetry repeaters, where an acoustic isolator according to the present invention can be implemented severally in a drillstring containing more than one source of acoustic energy, the sources acting in concert to extend the effective telemetry range achievable by any single acoustic source.

In summary, then: (1) the use of a tuning bar alone can essentially double the signal amplitude, but destructive out-of-phase reflected waves can nullify this benefit and possibly cancel out the desired signal altogether; (2) adding a reflector tube below the tuning bar reflects some of these harmful waves, but results in signal damage; and (3) adding a snubber below the reflector tube avoids the signal damage that would otherwise be caused by the reflector tube.

The present invention, by controlling acoustic impedance changes to provide at least two impedance mismatches, provides acoustic isolation of BHA components below the acoustic isolator, at the cost of an increase in total BHA length of only just over λ/2. This is a relatively small price to pay considering the improvement in isolation and signal amplitude, particularly when considering that the absence of the acoustic isolator may result in no signal at all being received at surface.

While a particular embodiment of the present invention has been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiment. For example, the tubular members (tuning bar, reflector tube, and snubber) may be formed from a single tube, the tube having various internal and external diameters along its length, which could facilitate ease of manufacture. Also, the reflector tube could be configured to contain short sections of greater external diameter in order to stabilize the isolator within the wellbore. The invention is therefore to be considered limited solely by the scope of the appended claims.

Embodiments of the invention in which an exclusive property or privilege is claimed are defined as follows:

1. An acoustic isolator for use with tubular assemblies comprising an acoustic wave transmitter, the acoustic isolator comprising, in series:
a first tubular member of first acoustic impedance adjacent the acoustic wave transmitter;
a second tubular member of second acoustic impedance, the first acoustic impedance being different than the second acoustic impedance; and
a third tubular member of third acoustic impedance, the third acoustic impedance being different than the second acoustic impedance;
whereby a first wave propagated toward the first tubular member is reflected back substantially in phase with a second wave propagated away from the first tubular member.

2. The acoustic isolator of claim 1 wherein the first tubular member is a λ/4 tuning bar, the second tubular member is an odd integer λ/4 multiple reflector tube, and the third tubular member is a snubber.

3. The acoustic isolator of claim 1 wherein the acoustic impedances of the first and third tubular members are generally equal.

4. The acoustic isolator of claim 1 wherein the third acoustic impedance is different than the first acoustic impedance.

5. A method for acoustically isolating a wave reflection source in a tubular assembly, the method comprising:
a. providing the tubular assembly with an acoustic wave transmitter;
b. providing the tubular assembly with, in series, a first tubular member of first acoustic impedance adjacent the acoustic wave transmitter, a second tubular member of second acoustic impedance, the first acoustic impedance being different than the second acoustic impedance, and a third tubular member of third acoustic impedance, the third acoustic impedance being different than the second acoustic impedance, wherein there is an acoustic impedance mismatch between the first and second tubular members and an acoustic impedance mismatch between the second and third tubular members, the first, second and third tubular members being positioned between the acoustic wave transmitter and the wave reflection source;
c. allowing the acoustic wave transmitter to propagate a first acoustic wave in a first direction along the tubular assembly toward the first tubular member;
d. allowing the acoustic wave transmitter to propagate a second acoustic wave in a second direction along the tubular assembly away from the first tubular member; and
e. allowing the acoustic impedance mismatches to cause reflection of the first wave substantially in phase with the second wave.
